(19) United States
(12) Patent Application Publication
(10) Pub. No.: US 2026/0130475 A1
(43) Pub. Date: May 14, 2026

(54) FINGER RING

(71) Applicant: Beijing Zitiao Network Technology Co., Ltd., Beijing (CN)

(72) Inventor: Junhui CHEN, Beijing (CN)

(21) Appl. No.: 19/292,837

(22) Filed: Aug. 6, 2025

(30) Foreign Application Priority Data
Nov. 10, 2024 (CN) 202411596311.9

(51) Int. Cl. A44C 15/00; A44C 9/00

(52) U.S. Cl. CPC A44C 15/0015; A44C 9/0053

(57) ABSTRACT

Embodiments of the disclosure provide a finger ring. The finger ring includes a housing configured to have an annular shape to be suitable for a user to wear on a finger; a speaker assembly arranged within the housing and including at least a speaker unit and a rear cavity arranged at a side of the speaker unit close to the finger, the rear cavity being in airflow communication with a sound emitting part of the speaker unit; and a rear cavity expansion component arranged within the housing and including a expansion cavity having a predetermined volume and at least one opening, the rear cavity expansion component being coupled to the speaker assembly via the at least one opening such that the rear cavity is in airflow communication with the expansion cavity.

### CROSS-REFERENCE

This application claims priority to the Chinese Patent Application No. 202411596311.9, filed with the Chinese Patent Office on November 10, 2024 and entitled “FINGER RING”, which is incorporated herein by reference in its entirety.

### FIELD

Embodiments of the present disclosure relate to the field of wearable devices, and more particularly, to a finger ring.

### BACKGROUND

With the rapid development of electronic technology and miniaturization technology, a conventional intelligent finger ring usually integrates complex circuitry inside, including various sensors. These electronic components are electrically interconnected, and a miniature rechargeable battery is built in to ensure continuous operation of the device.

The intelligent finger ring may establish a connection with a smart device such as a smart phone in an appropriate manner, so that the user may directly perform device control and information interaction through the finger ring worn on the finger without frequently operating a mobile phone, and such a convenient interaction manner is favored by more and more users.

### SUMMARY

A first aspect of the present disclosure provides a finger ring. The finger ring includes a housing configured to have an annular shape to be suitable for a user to wear on a finger; a speaker assembly arranged within the housing and including at least a speaker unit and a rear cavity arranged at a side of the speaker unit close to the finger, the rear cavity being in airflow communication with a sound emitting part of the speaker unit; and a rear cavity expansion component arranged within the housing and including a expansion cavity having a predetermined volume and at least one opening, the rear cavity expansion component being coupled to the speaker assembly via the at least one opening such that the rear cavity is in airflow communication with the expansion cavity.

By providing the rear cavity expansion component having the predetermined volume, the effective volume of the rear cavity is significantly increased, and the low-frequency effect of sound is improved. In an embodiment, the rear cavity expansion component is at least partially configured to be annular, for example, may follow the shape of the housing. In addition, this annular design not only maximizes the use of the limited space inside the finger ring but also provides uniform acoustic properties.

In some embodiments, the rear cavity expansion component is at least partially configured to be annular to follow the shape of the housing.

In some embodiments, the at least one opening is arranged at an end of the rear cavity expansion component in an extension direction and is coupled to a rear cavity wall for forming the rear cavity.

In some embodiments, the finger ring further includes: a sound conducting component arranged within the housing and including a conducting shell forming a conducting cavity and a first sound outlet hole formed on the conducting shell, and the conducting shell includes an inner side wall and an outer side wall arranged radially outward of the inner side wall, the inner side wall includes a sound input opening sealingly coupled to an outer side of the speaker assembly away from the finger for sound emitted by the sound emitting part to enter the conducting cavity through the sound input opening and be output from the first sound outlet hole.

In some embodiments, the first sound outlet hole includes at least one of: a side wall sound outlet hole penetrating through the outer side wall of the finger ring in a radial direction, and at least one end wall sound outlet hole penetrating through the conducting shell in an axial direction.

In some embodiments, the at least one end wall sound outlet hole includes a plurality of end wall sound outlet holes arranged on the conducting shell at intervals along a circumferential direction.

In some embodiments, the at least one end wall sound outlet hole or the side wall sound outlet hole includes at least one of: a micropore array arranged in a predetermined pattern or a slit.

In some embodiments, the first sound outlet hole is at least partially aligned with a second sound outlet hole formed on the housing.

In some embodiments, the sound input opening is aligned with the sound emitting part in a radial direction of the finger ring, and the finger ring further includes a sealing ring and/or a waterproof sound-permeable membrane arranged between the sound input opening and the speaker assembly.

In some embodiments, the housing further includes a sound pickup hole formed in an outer wall to allow sound to pass through the sound pickup hole into the housing, and the finger ring further includes: a microphone unit configured to receive an external sound transmitted from the sound pickup hole; and a communication unit configured to establish a data transmission link with an external device to transmit data; the communication unit is electrically connected to the microphone unit and transmits the external sound to the external device.

In some embodiments, the speaker unit is electrically connected to the communication unit, and the speaker unit plays sound data received via the communication unit.

In some embodiments, the finger ring further includes a button, the button includes at least one of a mechanical button, a capacitive button, or a pressure-sensitive button.

In some embodiments, the finger ring further includes a button unit arranged within the housing and coupled to the button, the button unit being configured to generate a press input signal in response to a press on the button by a user being received.

In some embodiments, the finger ring further includes: an indicator light unit electrically connected to the communication unit to output light having a predetermined frequency and/or a predetermined color based on at least a control signal provided by the communication unit; and/or a vibrator unit arranged in the cavity and electrically connected to the communication unit to vibrate based at least on a control signal provided by the communication unit.

In some embodiments, the finger ring further includes a battery unit including: a power management unit arranged within the housing; and a battery component arranged within the housing and coupled to the power management unit to at least power the speaker unit via the power management unit.

In some embodiments, the finger ring further includes a sensor arranged at least partially within the housing and configured to determine state data of the user based on the acquired information related to the user.

In some embodiments, the housing further includes an outer housing; and an inner housing arranged radially inward of the outer housing and sealingly coupled to the outer housing.

In some embodiments, the inner housing is formed through potting and curing.

### BRIEF DESCRIPTION OF THE DRAWINGS

The above and other objects, features and advantages of the present disclosure will become more apparent from the following more detailed description of example embodiments of the present disclosure in conjunction with the accompanying drawings, in which like reference symbols generally represent like parts in example embodiments of the present disclosure.

FIG. 1 shows a perspective view of a finger ring according to an embodiment of the present disclosure;

FIG. 2 illustrates a cross-sectional view of a finger ring including a rear cavity expansion component according to an embodiment of the present disclosure;

FIG. 3 illustrates an exploded view of a finger ring including a rear cavity expansion component according to an embodiment of the present disclosure;

FIG. 4 shows a perspective view of a finger ring including a second sound outlet hole on a side surface according to an embodiment of the present disclosure;

FIG. 5 illustrates an exploded view of a finger ring including a sound conducting component according to an embodiment of the present disclosure;

FIG. 6 illustrates a perspective view of a sound conducting component according to an embodiment of the present disclosure; and

FIG. 7 illustrates a cross-sectional view of a finger ring including a rear cavity expansion component and a sound conducting component, respectively, according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein. On the contrary, these embodiments are provided for a more thorough and complete understanding of the present disclosure. It should be understood that the drawings and embodiments of the present disclosure are for example purposes only and are not intended to limit the scope of the present disclosure.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The terms “first,” “second,” and the like may refer to different or identical objects. Other explicit and implicit definitions may also be included below.

The principles of the present disclosure will be described below with reference to several example embodiments shown in the accompanying drawings. While some embodiments of the present disclosure are shown in the accompanying drawings, it should be understood that these embodiments are described merely to enable those skilled in the art to better understand and then implement the present disclosure, and do not limit the scope of the present disclosure in any way.

Embodiments of the present disclosure may relate to data of a user, acquisition and/or use of data, and the like. These aspects all follow the corresponding laws and regulations and related regulations. In the embodiments of the present disclosure, all data is collected, obtained, processed, fabricated, forwarded, used, etc., all of which are performed on the premise that the user knows and confirms. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, the processing may be performed on the premise of having a legality basis (for example, obtaining consent of a personal information subject, or necessary for performing a fulfillment contract), and processing only within a specified or agreed range. If the user rejects personal information other than necessary information required by the basic function, it will not affect the use of the basic function by the user.

The intelligent finger ring serves as a miniature wearable device whose design faces a unique space limitation challenge. Since the finger ring needs to be worn on the finger of the user, the overall size of the finger ring must be kept within a reasonable range, which puts a very high requirement on the selection and layout of internal electronic components.

When a speaker is arranged on the finger ring, one of the most prominent technical pain points is the sound quality problem of the speaker. Since a potting process needs to fill the entire annular space, this causes a rear acoustic cavity of the speaker to be compressed into a very small space. The severe insufficient volume of the rear acoustic cavity directly affects the low-frequency effect of the sound, resulting in poor sound quality.

Another key technical difficulty is the adaptability of the sound outlet design when the microphone is arranged on the finger ring. Due to the fact that the user may wear the intelligent finger ring on different fingers of the left hand or the right hand, and different listening postures (such as ear sticking or keeping a certain distance) may be adopted during use, the sound outlet design at a single position is difficult to meet diversified use scenes. If the sound outlet is only provided at the top of the finger ring, the sound outlet may be shielded in some wearing positions, which seriously affects the sound the transmission effect of the sound.

The resolution of these technical difficulties requires innovation breakthrough in design. On the one hand, a new structural design scheme needs to be explored, and a larger volume of the rear acoustic cavity is provided on the premise of ensuring the waterproof sealing performance; on the other hand, the possibility of multi-directional sound production needs to be considered, for example, the arrangement scheme of multiple sound outlets is studied, or a novel sound guiding mechanism is developed, so that the ideal sound listening effect may be obtained under different wearing modes. In addition, these innovative solutions also need to consider compatibility with existing potting processes, ensuring the feasibility of the design and the reliability of the product.

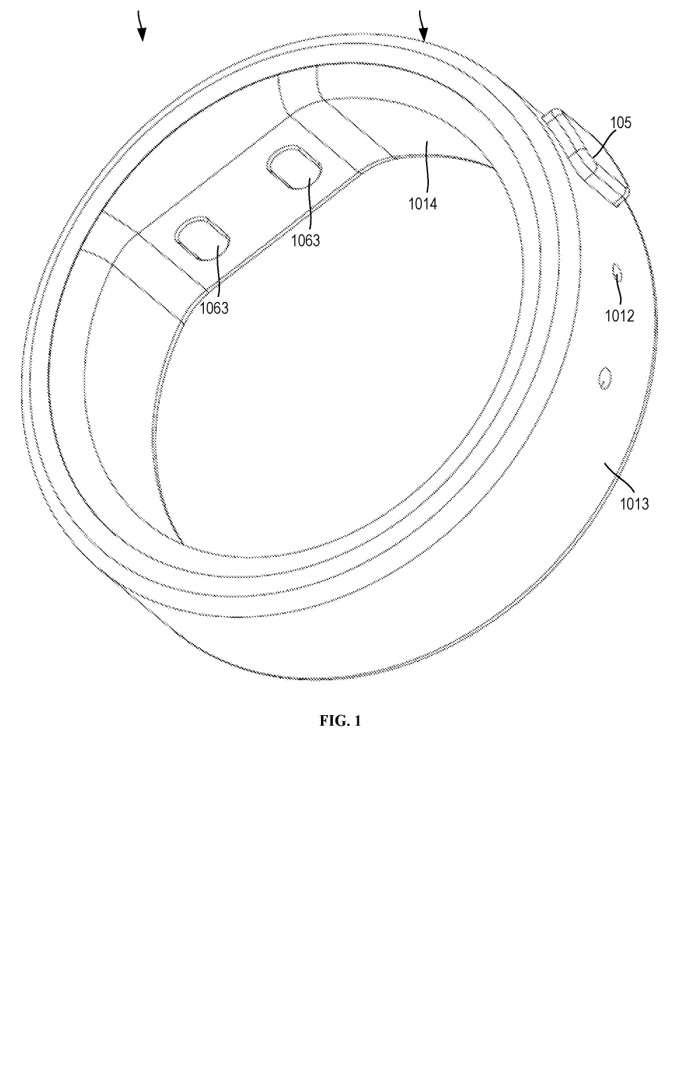

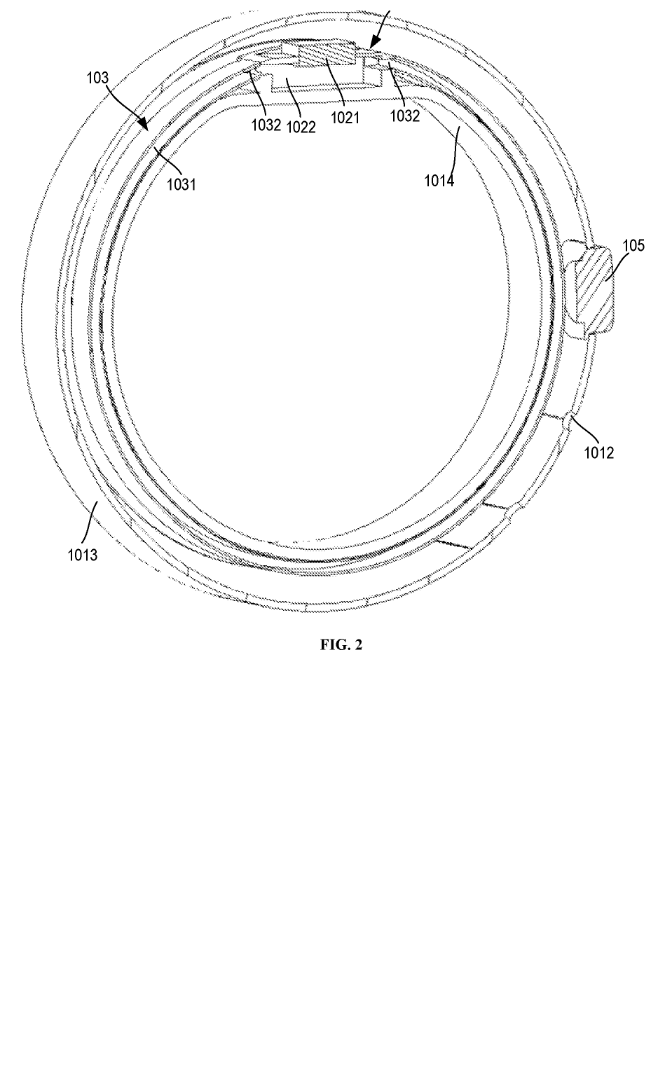

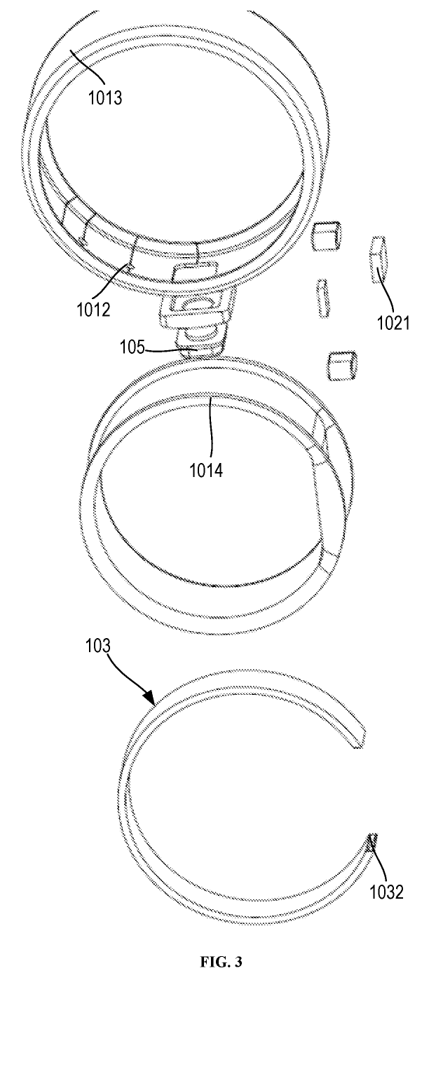

Embodiments of the present disclosure provide a finger ring 100 to solve or at least partially solve the problems of poor sound effect and single sound output manner in a traditional finger ring. FIG. 1 shows a perspective view of a finger ring according to an embodiment of the present disclosure; and FIGS. 2 and 3 show a cross-sectional view and an exploded view, respectively, of a finger ring including a rear cavity expansion component. As shown in FIGS. 1-3, a finger ring according to an embodiment of the present disclosure generally includes a housing 101, a speaker assembly 102, and a rear cavity expansion component 103.

The housing 101 is configured to have an annular shape to be suitable for a user to wear on a finger. The housing may be made of high-strength metal materials, ceramic materials or engineering plastics, and has sufficient structural strength and durability. A space for accommodating the functional components is provided inside the housing 101, and structures for mounting and fixing the functional components are designed in appropriate positions. In some embodiments, the housing 101 may adopt a split type design, including an inner housing and an outer housing, which facilitates installation and maintenance of the functional components. The specific structure of the housing in some embodiments will be further described below.

The speaker assembly 102 is arranged within the housing 101 and includes a speaker unit 1021 and a rear cavity 1022 arranged on a side of the speaker unit 1021 close to the finger. The speaker unit 1021 adopts a miniature speaker design, and its sound emitting part may adopt a piezoelectric ceramic or a moving coil structure. The rear cavity 1022 is in airflow communication with the sound emitting part of the speaker unit 1021 for providing a basic acoustic space. In some embodiments, the rear cavity 1022 may be formed in various suitable manners such as a separate housing or limiting other components, and an inner wall thereof may be designed with a specific structure to optimize the sound wave reflection effect.

An important feature of the present disclosure is the design of the rear cavity expansion component 103. The rear cavity expansion component 103 is arranged within the housing 101, including an expansion cavity 1031 having a predetermined volume and at least one opening 1032. The volume of the expansion cavity 1031 is accurately calculated and designed to provide the best acoustic effect. The rear cavity expansion component 103 is coupled to the speaker assembly 102 through the at least one opening 1032 such that airflow communication is formed between the rear cavity 1022 and the expansion cavity 1031. This design significantly increases the effective volume of the rear cavity and improves the low frequency effect of the sound. In an embodiment, the rear cavity expansion component 103 is at least partially configured to be an annular shape, for example, may follow the shape of the housing 101. This annular design not only maximizes the limited space inside the finger ring but also provides uniform acoustic properties.

In some embodiments, the position of the at least one opening 1032 is optimized to be arranged at the end of the rear cavity expansion component 103 in the extension direction and coupled to the rear cavity wall for forming the rear cavity 1022. The size and shape of the opening 1032 are also carefully designed to ensure sufficient airflow communication and avoid unnecessary acoustic losses. In some embodiments, the opening 1032 may be designed as a tapered channel structure to reduce airflow resistance.

In some embodiments, the rear cavity expansion component may have an annular shape and have two openings 1032 formed at two ends of the extension direction, as shown in FIG. 2. The two openings 1032 are respectively coupled to the speaker assembly 102, thereby facilitating the sound entering the rear cavity expansion component 103 through the openings 1032. In some alternative embodiments, the rear cavity expansion component 103 may also be only semi-annular or partially annular and has one opening 1032. Various available designs of the rear cavity expansion component 103 may facilitate optimizing the spatial layout inside the housing.

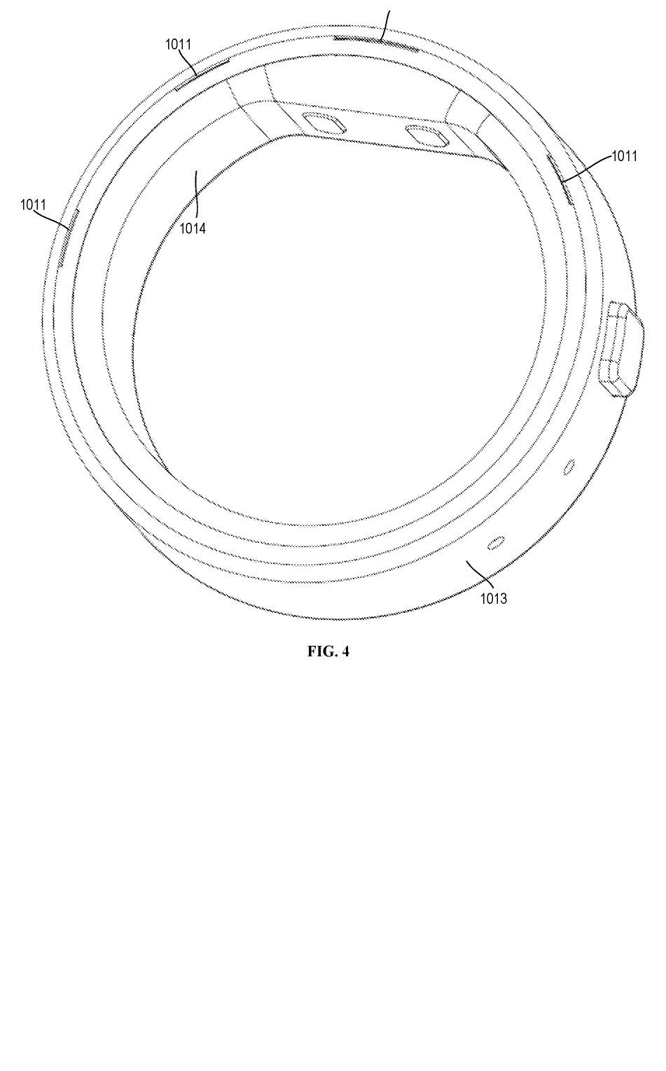

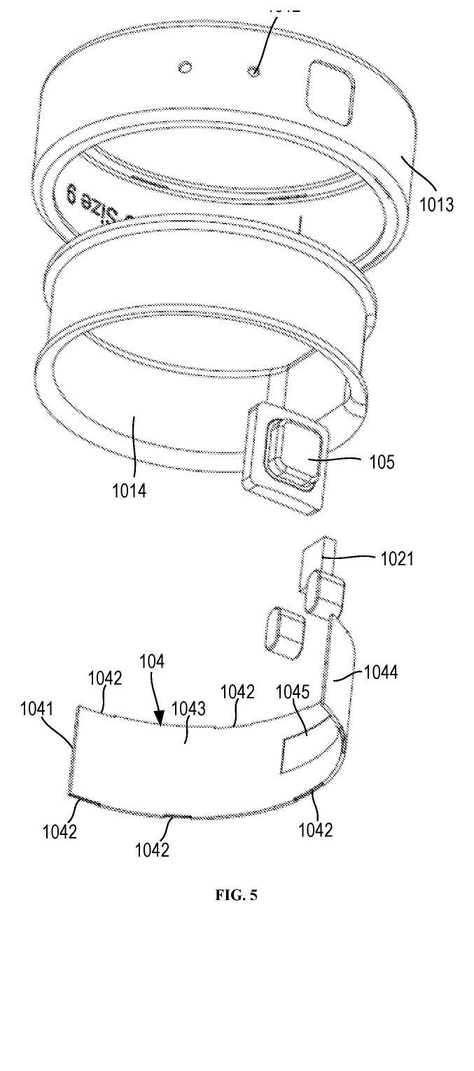

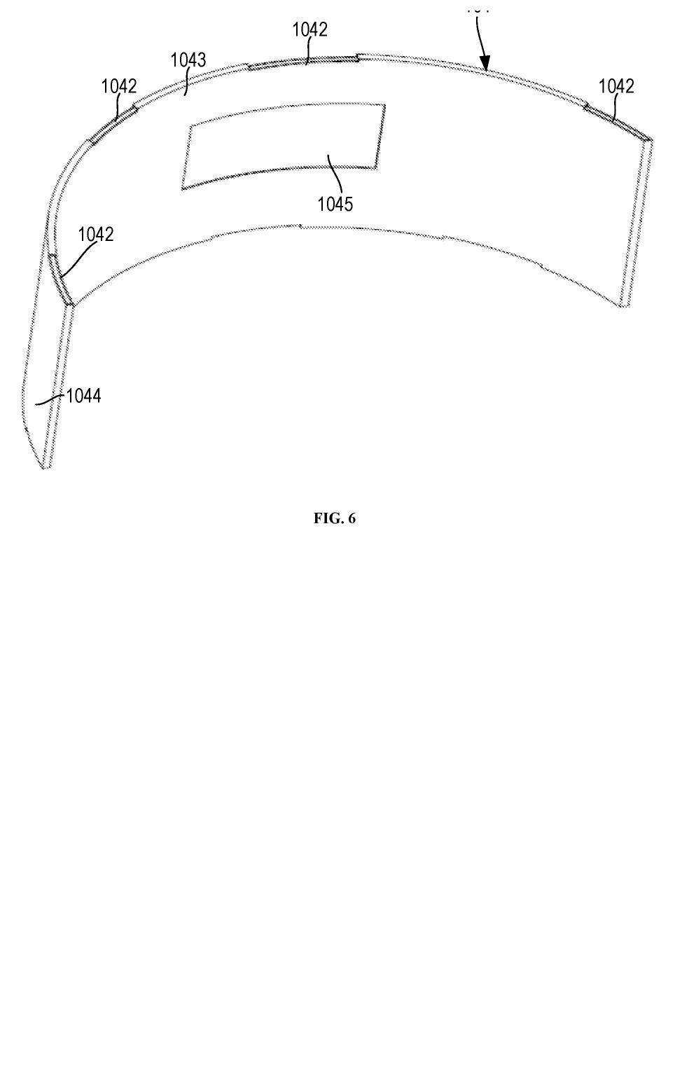

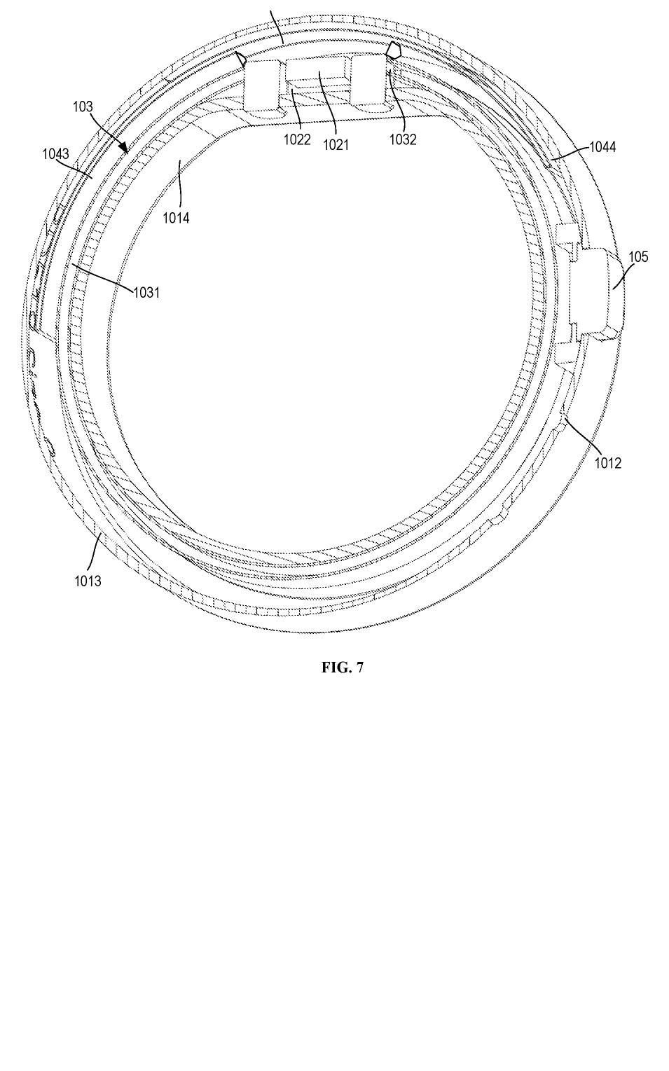

In some embodiments, the finger ring 100 further includes a sound conducting component 104, as shown in FIGS. 4-7. FIG. 4 shows a perspective view of a finger ring including a second sound outlet hole on a side according to an embodiment of the present disclosure; FIG. 5 shows an exploded view of a finger ring including a sound conducting component 104; FIG. 6 shows a perspective view of the sound conducting component 104; and FIG. 7 shows a cross-sectional view of a finger ring 100 including a rear cavity expansion component 103 and a sound conducting component 104.

The design of the sound conducting component 104 is another innovation point of the present disclosure. The sound conducting component 104 is arranged within the housing 101, including a conducting shell 1041 forming a conducting cavity and a first sound outlet hole 1042 formed on the conducting shell 1041. The conducting shell 1041 may be made of a suitable material to have good acoustic properties. The conducting shell 1041 includes an inner side wall 1043 and an outer side wall 1044 arranged radially outward of the inner side wall 1043. The conducting cavity formed between the inner side wall 1043 and the outer side wall 1044 may be acoustically optimized to provide an ideal acoustic wave propagation path.

The inner side wall 1043 is provided with a sound input opening 1045 positioned and dimensioned to achieve an optimized match with the sound emitting part of the speaker. The sound input opening 1045 forms a sealed coupling with the outer side of the speaker assembly 102, thereby ensuring sound output while ensuring that foreign matter and moisture do not enter the interior of the housing 101. This design enables sound emitted by the speaker to efficiently enter the conducting cavity via the sound input opening 1045 and ultimately output from the first sound outlet hole 1042.

In order to adapt to diversified wearing habits of users, the present disclosure innovates on sound outlet hole design. The first sound outlet hole 1042 includes two types: a side wall sound outlet hole penetrating through the outer side wall 1044 in a radial direction of the finger ring 100, and/or an end wall sound outlet hole penetrating through the conducting shell 1041 in an axial direction. In particular, in some embodiments, a plurality of end wall sound outlet holes are designed that are circumferentially and evenly arranged on the conducting shell 1041. The design of the multi-directional sound production ensures that no matter how the user wears the finger ring, a clear sound effect may be obtained.

Correspondingly, the housing may also be provided with a second sound outlet hole. The second sound outlet hole may also include a first outer wall sound outlet hole penetrating through the outer housing in the radial direction and/or a second outer wall sound outlet hole 1011 penetrating through the housing in the axial direction. The first outer wall sound outlet hole is at least partially aligned with the side wall sound outlet hole, and the second outer wall sound outlet hole 1011 is at least partially aligned with the end wall sound outlet hole, thereby facilitating sound output through the first sound outlet hole and the second sound outlet hole.

In some embodiments, in order to further optimize the sound output, the end wall sound outlet holes or the side wall sound outlet holes may be designed by using an array of micro holes, and the micro holes are arranged in a specific pattern, so that the sound transmission effect may be ensured, and the necessary protection performance may be provided. In addition, in some embodiments, alternatively or additionally, the at least one end wall sound outlet hole or the side wall sound outlet hole may also adopt a slit structure, which achieves an ideal acoustic effect by optimizing the width, length and arrangement of the slit.

In some embodiments, in order to improve waterproof and dustproof performance, a sealing ring and/or a waterproof sound-permeable membrane is provided between the sound input opening 1045 and the speaker assembly 102. The sealing ring may be made of an elastic material, which may provide sufficient elastic deformation space while ensuring the sealing effect. The waterproof sound-permeable membrane is made of an appropriate material, and has excellent sound-permeable performance and waterproof performance. The design positions of the protection measures are optimized, so that the sound conducting effect is not influenced, and reliable protection performance may be provided.

For ease of description, in the following, the speaker assembly 102 together with some of the electrical units mentioned below will be collectively referred to as a functional assembly. In some embodiments, the housing 101 also has a sound pickup hole 1012 formed in the outer wall. The sound pickup hole 1012 allows sound to pass therethrough into the cavity formed by the housing 101. In some embodiments, in order to ensure that the sound may enter the interior of the cavity and ensure the waterproof and dustproof capability of the finger ring, the waterproof sound-permeable membrane may be provided inside the outer wall of the sound pickup hole 1012. The waterproof sound-permeable membrane may effectively prevent a risk of the water entering the interior of the cavity to damage to the functional assembly, and also allows the sound to pass therethrough and into the interior of the cavity.

In some embodiments, in order to facilitate the user to input sound through the sound pickup hole 1012, the sound pickup hole 1012 is located on an outer wall of the finger ring at a side of the thumb or the sound pickup hole 1012 is located on an outer wall of the finger ring at a side of the finger back in a state where the finger ring is worn on the index finger. In this way, when the user needs to use the finger ring to input a voice instruction or voice information, the user lifts the hand wearing the finger ring and places it near the mouth, the sound pickup hole 1012 may be close to the mouth of the user, and thus the voice output by the user is conveniently entered into the cavity, and the sound pickup performance of the finger ring is improved.

In some embodiments, the functional assembly provided in the finger ring may further include a microphone unit and a communication unit. The communication unit may establish a data transmission link with an external device via appropriate means and transmit data, where the appropriate means may include, but are not limited to, Bluetooth, Wi-Fi, cellular network, or near field communication (NFC), and the like. Considering the low power transmission performance of Bluetooth, the embodiments of the present disclosure will mainly describe the concept according to the present disclosure mainly by connecting the finger ring to the external device through Bluetooth. It should be understood that other communication means are similar, and details are not described herein again. In addition, the external device may include, but is not limited to, a terminal device such as a mobile phone, a notebook computer, a tablet computer or a desktop computer, and an earphone or a sound box.

The microphone unit is configured to receive the external sound transmitted from the sound pickup hole 1012 and electrically connected to the communication unit to transmit the external sound to the external device through the communication unit. By equipping the microphone unit, in some use scenarios, for example, when the user does not conveniently take out an external device such as a mobile phone, the user may use the microphone unit on the finger ring to input the voice information or voice instruction to the external device to conveniently control the external device to perform various functions or input information. In this way, the user experience when the user uses the finger ring and the external device may be significantly improved.

In some embodiments, the speaker assembly 102 may be electrically connected to the communication unit and configured to play sound data received via the communication unit. In this way, the user does not need an earphone or other sound output devices to conveniently hear the sound through the finger ring, thereby further improving the user experience.

In some embodiments, the finger ring may further include a sealing ring. For ease of description, the sealing ring will hereinafter be referred to as a first sealing ring. The first sealing ring is arranged in a microphone cavity for accommodating the microphone unit and is located between the outer wall and the microphone unit to form a sound pickup cavity between the sound pickup hole 1012 and the microphone unit. In this way, the sound pickup performance of the microphone unit may be further improved.

In some embodiments, to facilitate the user to operate the finger ring, the finger ring may further include a button 105. The button 105 may include at least one of a mechanical button, a capacitive button, and a pressure-sensitive button. For ease of description, the concept of the present disclosure will be described mainly by using the mechanical button as an example of the button 105, and it should be understood that the button 105 in other forms is also similar, and will not be repeated hereinafter.

In some embodiments, when the finger ring is in a wearing state, the button 105 is located on the finger ring at a side of the thumb. In this way, the user may conveniently press and operate the button 105. In some embodiments, the functional assembly further includes a button unit. The button unit is arranged in the cavity and coupled to the button 105. The button unit is configured to generate a press input signal in response to a press on the button 105 by a user being received. The press input signal may be transmitted to the external device through the communication unit, thereby providing input to the external device to thereby implement corresponding functions. In addition, in some embodiments, the press input signal may also be used to directly control the opening and closing of the microphone unit and/or the speaker unit, which will be further described below.

In some embodiments, to facilitate the mounting of the button 105 and facilitate the user to press, the housing 101 includes a button hole, and the cavity further includes a button cavity corresponding to the button hole. One end of the button 105 is connected to the button unit within the button cavity, and the other end of the button 105 is exposed to the outside through the button hole for the user to press.

In some embodiments, in order to prevent foreign matters such as moisture or dust from entering the interior of the cavity through the button hole, the finger ring may further include a second sealing ring. The second sealing ring is arranged in the button cavity and surrounds the button hole. The second sealing ring includes an isolation layer arranged between the button 105 and the button unit. In this way, the button unit may be effectively isolated in the closed button cavity, and meanwhile the user may be allowed to press the button 105 exposed to the outside, thereby improving the waterproof performance and improving the user experience.

In some embodiments, the functional assembly may further include a processor arranged in the cavity. The processor is configured to control on or off of the microphone unit based on the press input signal. That is, the processing unit may be coupled to the button unit, and cause the microphone unit to be closed or opened by the user in response to a press input signal generated by the user pressing the button 105. For example, when the user needs to input a voice instruction to an external device, the user may turn on the microphone unit by a long press (or other appropriate pressing mode) and input sound to the microphone unit. In some embodiments, the processor may also control the opening or closing of the speaker unit based on the press input signal.

Of course, it should be understood that the above examples of controlling the opening or closing of the microphone unit and/or the speaker unit by the button 105 are merely illustrative and are not intended to limit the scope of the present disclosure. The button 105 and the button unit may also have other uses, and the microphone unit or the speaker unit may be turned on or off in other manners. For example, in some embodiments, the press input signal sent by the button unit may also provide a corresponding input for other functions of the external device to implement corresponding functions. In some embodiments, the microphone unit or the speaker unit may also be turned on or off through control by the external device.

In some embodiments, the finger ring may provide output of light and/or vibration in addition to providing sound output through the speaker assembly 102. For example, in some embodiments, the functional assembly may further include an indicator light unit. The indicator light unit is electrically connected to the communication unit to output light having a predetermined frequency and/or a predetermined color based on at least the control signal provided by the communication unit. For example, the external device may output the specified signal to the indicator light unit via the communication unit. The indicator light outputs light of flashing, normally lighting (predetermined time), single-color and/or multi-color alternation, and the like based on a corresponding signal.

In some embodiments, the indicator light unit may be arranged in an indicator light cavity of the housing 101. The indicator light cavity has a light output portion formed on the outer wall of the housing 101, thereby allowing the light to be emitted out of the indicator light cavity. In some embodiments, the light output portion may be a through hole formed in the outer wall. In this case, in order to keep the indicator light cavity in a closed state while transmitting light, a light transmissive but air impermeable material may be provided in the through hole. In some embodiments, the light output portion may also be a transparent portion or a translucent portion formed on the outer wall.

In some embodiments, the light output portion may have an appropriate shape and size. For example, in some embodiments, the light output portion may be a through hole for light to pass through, and a cross-sectional shape of the through hole may include, but is not limited to, a circle, an ellipse, a square, a triangle, a star, a polygon, or other suitable regular or irregular shapes. In some embodiments, alternatively or additionally, the indicator light cavity also has a light output portion formed on the side wall. In such embodiments, the light output portion may also be a light band extending along at least a portion of the contour of the finger ring. That is, for the light output portion formed on the side wall, it may have a semi-annular shape or an annular shape.

In some embodiments, the finger ring 100 may further include a vibrator unit (not shown). The vibrator unit is arranged within the housing 101 and is electrically connected to the communication unit to vibrate at least based on a control signal provided by the communication unit. For example, when the external device has an item that needs to be processed by the user, the external device may send a control signal to the vibrator unit through the communication unit to control the vibrator to vibrate, thereby reminding the user to process the item presented in the external device.

In some embodiments, the finger ring may further include a battery unit. The battery unit may include a battery management unit and a battery component. The power management unit is arranged within the housing 101, for example a battery management cavity in the housing 101. The battery component is also arranged within the housing 101, for example a battery cavity in the housing 101, and is coupled to the power management unit to power the functional assembly, including the speaker assembly 102 and the like, via the power management unit. The battery management unit may manage power supply of the battery component to each unit in the functional assembly, thereby ensuring normal operation of each unit. The battery component may have a shape corresponding to the annular cavity of the finger ring, so that the battery having a larger capacity may be arranged in a limited space to ensure the endurance of the finger ring.

In some embodiments, the battery unit may further include a charging contact 1063 and/or a wireless charging module. Specifically, a pair of charging contacts 1063 are arranged to be exposed outside of the housing 101 and are coupled to the power management unit so as to be connected to an external charging terminal to charge the battery component. The pair of charging contacts 1063 may be arranged inside the finger ring. When charging is required, the user may remove the finger ring from the finger and couple the charging contact 1063 with the external charging terminal to subsequently charge the battery component.

In some embodiments, as mentioned above, the battery unit may further include a wireless charging module arranged within the housing 101 and configured to couple with an external charging coil to charge the battery component. At least a portion of the wireless charging module may be arranged in the cavity or a wall of the housing 101 (e.g., the outer housing 1013 or the inner housing 1014 to be mentioned hereinafter) to facilitate coupling with the external charging coil to charge the battery component.

In some embodiments, the housing 101 may further include an outer housing 1013 and an inner housing 1014. The outer housing 1013 includes the sound pickup hole 1012 formed thereon mentioned above. In some embodiments, similar to the sound pickup hole 1012, the second sound outlet hole 1011 and/or the button hole mentioned above may also be formed on the outer housing 1013. The outer housing 1013 may have a complete annular shape, and the cross section in the radial direction may be in a U-shaped shape, thereby facilitating arrangement of various units in the functional assembly. The inner housing 1014 is arranged radially inward of the outer housing 1013 and sealingly coupled to the outer housing 1013 to form a cavity. In some embodiments, similar to the outer housing 1013, the inner housing 1014 may also have a complete annular shape, and the cross section in the radial direction may also be in a U-shaped shape, thereby facilitating the arrangement of various units in the functional assembly. As mentioned above, in some embodiments, at least a portion of the wireless charging module (e.g., a charging coil) may be arranged in the inner housing 1014 or the outer housing 1013.

In some embodiments, the inner housing 1014 may be formed through potting and curing. Specifically, the outer housing 1013 may be placed in an appropriate position in a mold first, and the aforementioned various units of the functional assembly may be placed according to predetermined positions. After each unit of the functional assembly is placed in the appropriate position of the outer housing 1013, the position of each unit may be fixed by an appropriate fixture, and the liquid colloid is poured into the mold. Appropriate grinding or trimming may be performed after the colloid is cured, to form a sealed cavity while forming the inner housing 1014. In this way, the finger ring may be more conveniently manufactured and the sealing performance is better, and the sealing and waterproof performance of the finger ring are improved.

In some embodiments, to facilitate arranging the various units of the functional assembly in the annular cavity, various units in the functional assembly may be arranged on a flexible printed circuit board to place the functional assembly along the annular cavity of the finger ring. The flexible circuit board may have a certain strength, or have a certain structural strength only in a specific position, so as to provide support when the button 105 is pressed, thereby ensuring the reliability of the finger ring and the corresponding unit.

In some embodiments, the functional assembly included in the finger ring further include: a sensor at least partially arranged within the housing 101 and is configured to determine state data of the user based on the acquired information related to the user.

In some embodiments, the sensors may include GPS, IMU, etc., to obtain motion information of the user.

In some embodiments, the sensors may include a motion sensor and/or a health sensor. For example, the health sensor is at least partially arranged within the housing 101 and is configured to determine health data of the user based on the acquired physical sign information of the user, the health data including at least one of: heart rate, blood pressure, and blood oxygen saturation. These health data may be transmitted to the external device via the communication unit for use by the external device to further use and process the health data to further improve user experience.

For example, the health sensor may include a heart rate sensor, a blood oxygen sensor, a pressure sensor, a temperature sensor, an acceleration sensos, a galvanic skin response (EDA) sensor, and/or a bioimpedance analysis (BIA), and the like. The heart rate sensor may use photoplethysmography (PPG) technology or electrocardiogram (ECG) technology to monitor heart rate and heart rate variability (HRV). The blood oxygen sensor may utilize PPG sensors of red and infrared light to estimate the saturation of oxygen in the blood. The temperature sensor may measure the temperature of skin surface or inside the body for monitoring body temperature changes. The pressure sensor may detect a change in pressure of the gas or liquid, for blood pressure monitoring, and the like. The acceleration sensor may measure body motion and amount of activity for motion tracking. The EDA sensor may be used to measure skin electrical activity for monitoring pressure and emotional states. The BIA sensor may measure the body fat rate and moisture by sending a small current through the body. In addition to the sensors mentioned above, the finger ring may also include a proximity sensor to detect the presence of nearby objects, for gesture recognition and contactless interaction, and the like.

Various embodiments of the present disclosure have been described above, which are example, not exhaustive, and are not limited to the embodiments disclosed. Many modifications and variations will be apparent to those of ordinary skill in the art without departing from the scope of the illustrated embodiments. The selection of the terms used herein is intended to best explain the principles of the embodiments, practical applications, or technical improvements to the techniques in the marketplace, or to enable others of ordinary skill in the art to understand the embodiments disclosed herein.

1. A finger ring comprising:
a housing configured to have an annular shape to be suitable for a user to wear on a finger;
a speaker assembly arranged within the housing and comprising at least a speaker unit and a rear cavity arranged at a side of the speaker unit close to the finger, the rear cavity being in airflow communication with a sound emitting part of the speaker unit; and
a rear cavity expansion component arranged within the housing and comprising a expansion cavity having a predetermined volume and at least one opening, the rear cavity expansion component being coupled to the speaker assembly via the at least one opening such that the rear cavity is in airflow communication with the expansion cavity.

2. The finger ring of claim 1, wherein the rear cavity expansion component is at least partially configured to be annular to follow the shape of the housing.

3. The finger ring of claim 1, wherein the at least one opening is arranged at an end of the rear cavity expansion component in an extension direction and is coupled to a rear cavity wall for forming the rear cavity.

4. The finger ring of claim 1, further comprising:
a sound conducting component arranged within the housing and comprising a conducting shell forming a conducting cavity and a first sound outlet hole formed on the conducting shell, and
wherein the conducting shell comprises an inner side wall and an outer side wall arranged radially outward of the inner side wall,
the inner side wall comprises a sound input opening sealingly coupled to an outer side of the speaker assembly away from the finger for sound emitted by the sound emitting part to enter the conducting cavity through the sound input opening and be output from the first sound outlet hole.

5. The finger ring of claim 4, wherein the first sound outlet hole comprises at least one of: a side wall sound outlet hole penetrating through the outer side wall of the finger ring in a radial direction, and at least one end wall sound outlet hole penetrating through the conducting shell in an axial direction.

6. The finger ring of claim 5, wherein the at least one end wall sound outlet hole comprises a plurality of end wall sound outlet holes arranged on the conducting shell at intervals along a circumferential direction.

7. The finger ring of claim 5, wherein the at least one end wall sound outlet hole or the side wall sound outlet hole comprises at least one of: a micropore array arranged in a predetermined pattern or a slit.

8. The finger ring of claim 4, wherein the first sound outlet hole is at least partially aligned with a second sound outlet hole formed on the housing.

9. The finger ring of claim 4, wherein the sound input opening is aligned with the sound emitting part in a radial direction of the finger ring, and the finger ring further comprises a sealing ring and/or a waterproof sound-permeable membrane arranged between the sound input opening and the speaker assembly.

10. The finger ring of claim 1, wherein the housing further comprises a sound pickup hole formed in an outer wall to allow sound to pass through the sound pickup hole into the housing, and the finger ring further comprises:
a microphone unit configured to receive an external sound transmitted from the sound pickup hole; and
a communication unit configured to establish a data transmission link with an external device to transmit data; wherein the communication unit is electrically connected to the microphone unit and transmits the external sound to the external device.

11. The finger ring of claim 10, wherein the speaker unit is electrically connected to the communication unit, and the speaker unit plays sound data received via the communication unit.

12. The finger ring of claim 1, further comprising a button, wherein the button comprises at least one of a mechanical button, a capacitive button, or a pressure-sensitive button.

13. The finger ring of claim 12, further comprising a button unit arranged within the housing and coupled to the button, the button unit being configured to generate a press input signal in response to a press on the button by a user being received.

14. The finger ring of claim 10, further comprising:
an indicator light unit electrically connected to the communication unit to output light having a predetermined frequency and/or a predetermined color based on at least a control signal provided by the communication unit; and/or a vibrator unit arranged in the cavity and electrically connected to the communication unit to vibrate based at least on a control signal provided by the communication unit.

15. The finger ring of claim 1, further comprising:
a battery unit, comprising:
a power management unit arranged within the housing; and
a battery component arranged within the housing and coupled to the power management unit to at least power the speaker unit via the power management unit.

16. The finger ring of claim 1, further comprising:
a sensor arranged at least partially within the housing and configured to determine state data of the user based on the acquired information related to the user.

17. The finger ring of claim 1, wherein the housing further comprises:
an outer housing; and
an inner housing arranged radially inward of the outer housing and sealingly coupled to the outer housing.

18. The finger ring of claim 17, wherein the inner housing is formed through potting and curing.
